(19) United States
(12) Patent Application Publication
(10) Pub. No.: US 2016/0134024 A1
(43) Pub. Date: May 12, 2016

(54) METHOD AND APPARATUS FOR TRANSMITTING DATA, AND METHOD AND APPARATUS FOR RECEIVING DATA

(71) Applicant: Electronics and Telecommunications Research Institute, Daejeon (KR)

(72) Inventors: Gosan NOH, Daejeon (KR); Youn Ok PARK, Daejeon (KR)

(21) Appl. No.: 14/737,031

(22) Filed: Jun. 11, 2015

(30) Foreign Application Priority Data
Nov. 11, 2014 (KR) 10-2014-0156421

(51) Int. Cl. H01Q 21/06; H04L 27/00; H01Q 3/30

(52) U.S. Cl. CPC H01Q 21/061; H01Q 3/30; H04L 27/0012

(57) ABSTRACT

A data transmitting apparatus in a wireless communication system determines a beam angle according to an input bit signal sequence and forms a pencil beam in a direction of the beam angle that is determined using a plurality of transmitting antennas.

### CROSS-REFERENCE TO RELATED APPLICATION

This application claims priority to and the benefit of Korean Patent Application No. 10-2014-0156421 filed in the Korean Intellectual Property Office on Nov. 11, 2014, the entire contents of which are incorporated herein by reference.

### BACKGROUND OF THE INVENTION

(a) Field of the Invention

The present invention relates to a method and apparatus for transmitting data, and a method and apparatus for receiving data. More particularly, the present invention relates to a data modulation technology in a wireless communication system using a millimeter wave frequency band.

(b) Description of the Related Art

In a wireless communication system, data modulation is an essential element for transmitting data without a loss in a radio channel.

Data modulation performs a function of changing a digital signal to an analog waveform appropriate to wireless transmission, and in data modulation, a basic modulation method such as Amplitude Shift Keying (ASK), Frequency Shift Keying (FSK), Phase Shift Keying (PSK) exists, and a modulation method such as Quadrature Amplitude Modulation (QAM) in which the above methods are mixed exists.

Nowadays, in addition to a basic modulation method, a spatial modulation method that transfers data through transmitting antenna selection of a multiple antenna system and a polarization modulation method using polarization state characteristics of a polarization antenna as a data transfer means are suggested. Space modulation and polarization modulation may be used as a method of enhancing frequency efficiency without additional injection of a radio resource by combining with an existing modulation technique.

In millimeter wave communication using a frequency between tens of gigahertz and hundreds of gigahertz, and terahertz wave communication using several terahertz frequencies, pencil beamforming can be performed using a characteristic of a millimeter wave and a terahertz wave having a short wavelength and strong straightness. Because a gap between antennas may be reduced due to a very short wavelength, antennas of several tens or more may be integrated, and thus by forming a pencil beam in which a beam width is very narrow and in which an antenna gain is very large, a spatial focus effect can be obtained. Further, beam steering that changes a beam direction to a desired direction using a phase shifter in an array antenna may be performed. Such pencil beamforming may be applied to beam multiplexing and beam-division multiple access.

However, such conventional art has a limitation that it cannot appropriately use narrow beam characteristics of a pencil beam in a modulation process.

### SUMMARY OF THE INVENTION

The present invention has been made in an effort to provide a method and apparatus for transmitting data and a method and apparatus for receiving data having advantages of being capable of modulating data using a characteristic of a millimeter wave or terahertz wave-based pencil beam having a very narrow beam width and a very strong antenna gain.

An exemplary embodiment of the present invention provides a method of transmitting data of a data transmitting apparatus in a wireless communication system. The method includes: determining a beam angle according to an input bit signal sequence of a determined size; and forming a pencil beam in a direction of the determined beam angle using a plurality of transmitting antennas.

A plurality of beam angles that are modulated by the plurality of transmitting antennas may correspond one-to-one to a plurality of receiving antennas in a data receiving apparatus.

The determining of a beam angle may include: generating a modulation symbol by modulating some bits of the input bit signal sequence with a digital modulation method; and forming the pencil beam by forming a beam of the modulation symbol and determining the beam angle using the remaining bits of the input bit string.

The forming of a pencil beam may include: dividing the plurality of transmitting antennas into a plurality of transmitting antenna regions; and forming a pencil beam in a direction of a beam angle that is determined for different input bit signal sequences at each of the plurality of transmitting antenna regions.

Angles of a plurality of beams that are modulated at each of the plurality of transmitting antenna regions may correspond one-to-one to a plurality of receiving antennas of a receiving antenna region corresponding to each of the plurality of transmitting antenna regions.

Another embodiment of the present invention provides a method of receiving data of a data receiving apparatus in a wireless communication system. The method includes: receiving at least one pencil beam that is applied with a beam angle that is determined by the data transmitting apparatus; detecting at least one receiving antenna that receives at least one applied pencil beam among a plurality of receiving antennas; detecting a beam angle corresponding to an index of the detected receiving antenna; and demodulating a bit signal sequence according to the detected beam angle.

A plurality of beam angles that are modulated by the plurality of transmitting antennas may correspond one-to-one to a plurality of receiving antennas.

The demodulating of a bit signal sequence may include: detecting some bits of the bit signal sequence corresponding to the detected beam angle; and detecting the remaining bits of the bit signal sequence by demodulating a signal that is received through the pencil beam with a determined digital demodulation method.

The receiving of at least one pencil beam may include receiving pencil beams that are simultaneously applied in a beam angle that is determined for each of different input bit signal sequences at each of a plurality of receiving antenna regions, and the plurality of receiving antennas may be divided into the plurality of receiving antenna regions.

Angles of a plurality of beams that are modulated at each of the plurality of transmitting antenna regions may correspond one-to-one to a plurality of receiving antennas of a receiving antenna region corresponding to each of the plurality of transmitting antenna regions.

Yet another embodiment of the present invention provides a data transmitting apparatus in a wireless communication system. The data transmitting apparatus includes a modulator and a transmitter. The modulator determines a beam angle according to an input bit signal sequence of a determined size. The transmitter includes a plurality of transmitting antennas, and forms a pencil beam in a direction of the beam angle that is determined using the plurality of transmitting antennas.

The modulator may modulate some bits of the input bit signal sequence with a digital modulation method, form the pencil beam including a modulated signal, and determine a beam angle of the pencil beam using the remaining bits of the input bit signal sequence.

A plurality of beam angles that are modulated by the plurality of transmitting antennas may correspond one-to-one to a plurality of receiving antennas in a data receiving apparatus.

The transmitter may divide the plurality of transmitting antennas into a plurality of transmitting antenna regions, and simultaneously form a pencil beam in a direction of a beam angle that is determined for each of different input bit signal sequences at each of the plurality of transmitting antenna regions.

Angles of a plurality of beams that are modulated at each of the plurality of transmitting antenna regions may correspond one-to-one to a plurality of receiving antennas of a receiving antenna region corresponding to each of the plurality of transmitting antenna regions.

Yet another embodiment of the present invention provides a data receiving apparatus in a wireless communication system. The data receiving apparatus includes a receiver, a receiving antenna detector, and a demodulator. The receiver includes a plurality of receiving antennas, and receives at least one pencil beam that is applied with a beam angle that is determined by a data transmitting apparatus through at least one receiving antenna of the plurality of receiving antennas. The receiving antenna detector detects at least one receiving antenna that receives the at least one pencil beam among a plurality of receiving antennas. The demodulator detects a beam angle corresponding to an index of the detected receiving antenna and demodulates a bit signal sequence according to the detected beam angle.

The demodulator may detect some bits of the bit signal sequence corresponding to a detected beam angle, and detect the remaining bits of the bit signal sequence by demodulating a signal that is received through the pencil beam with a determined digital demodulation method.

Angles of a plurality of beams that are modulated by the plurality of transmitting antennas may correspond one-to-one to a plurality of receiving antennas.

The receiver may divide the plurality of receiving antennas into the plurality of receiving antenna regions, and receive pencil beams that are simultaneously applied to an beam angle that is determined for each of different input bit signal sequences at each of the plurality of receiving antenna regions.

Angles of a plurality of beams that are modulated at each of the plurality of transmitting antenna regions may correspond one-to-one to a plurality of receiving antennas of a receiving antenna region corresponding to each of the plurality of transmitting antenna regions.

### BRIEF DESCRIPTION OF THE DRAWINGS

FIG. 1 is a diagram illustrating a wireless communication system according to an exemplary embodiment of the present invention.

FIG. 2 is a flowchart illustrating a method of transmitting data according to an exemplary embodiment of the present invention.

FIG. 3 is a flowchart illustrating a method of receiving data according to an exemplary embodiment of the present invention.

FIG. 4 is a diagram illustrating a wireless communication system according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for transmitting data and a method and apparatus for receiving data according to an exemplary embodiment of the present invention will be described in detail with reference to the drawings.

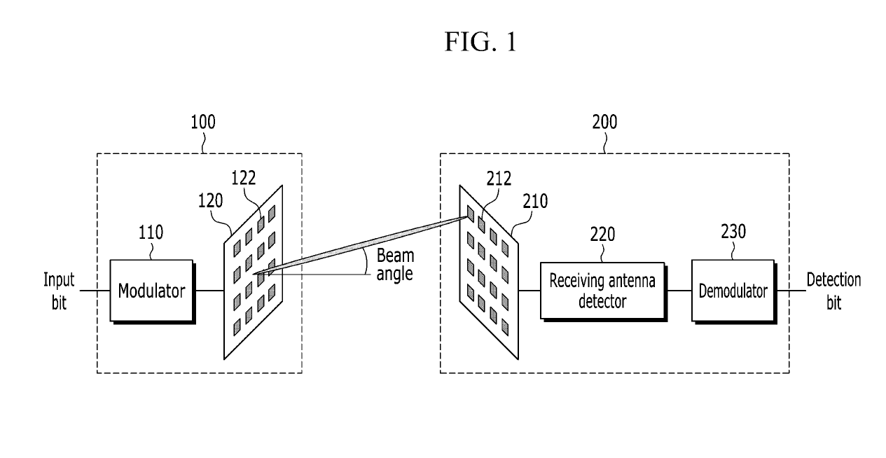

FIG. 1 is a diagram illustrating a wireless communication system according to an exemplary embodiment of the present invention.

Referring to FIG. 1, the wireless communication system includes a data transmitting apparatus 100 and a data receiving apparatus 200. The data transmitting apparatus 100 and the data receiving apparatus 200 perform communication using a millimeter wave frequency band between tens of Gigahertz or hundreds of Gigahertz or a terahertz wave band of several terahertz.

The data transmitting apparatus 100 includes a modulator 110 and a transmitter 120.

The data receiving apparatus 200 includes a receiver 210, a receiving antenna detector 220, and a demodulator 230.

In the data transmitting apparatus 100, the modulator 110 determines a beam angle according to an input bit signal sequence, and the transmitter 120 forms a pencil beam in a direction of the determined beam angle and transmits the pencil beam.

The transmitter 120 includes a plurality of transmitting antennas 122. The plurality of transmitting antennas 122 may be disposed in a two-dimensional array. A plurality of transmitting antennas 122 are referred to as a transmitting array antenna. The plurality of transmitting antennas 122 form a pencil beam in a direction of a beam angle that is determined by the modulator 110 based on the center of a transmitting array antenna. In order to adjust a beam angle of the plurality of transmitting antennas 122 in a direction of a beam angle that is determined by the modulator 110, the transmitter 120 may further include a phase shifter (not shown). The transmitter 120 may use a high gain directional antenna such as a horn antenna.

In the data receiving apparatus 200, the receiver 210 receives a pencil beam that is applied with a beam angle that is determined by the transmitter 120.

The receiver 210 includes a plurality of receiving antennas 212. The plurality of receiving antennas 212 may be disposed in a two-dimensional array.

The receiving antenna detector 220 detects a receiving antenna, having received an applied pencil beam among the plurality of receiving antennas 212.

The number of beam angles that are modulated in a transmitting antenna and the number of receiving antennas that can be distinguished in a receiving antenna array are the same, and the beam angle and the receiving antenna correspond one-to-one. A corresponding relationship of the beam angle and the receiving antenna may be previously shared between the data transmitting apparatus 100 and the data receiving apparatus 200 using a training signal. When modulating a beam angle in such a configuration, a magnitude of a constellation that can be distinguished corresponds with the number of receiving antennas.

When a receiving antenna having received a pencil beam is detected, the demodulator 230 detects a beam angle corresponding to an index of a corresponding receiving antenna and detects an input bit signal sequence according to the detected beam angle.

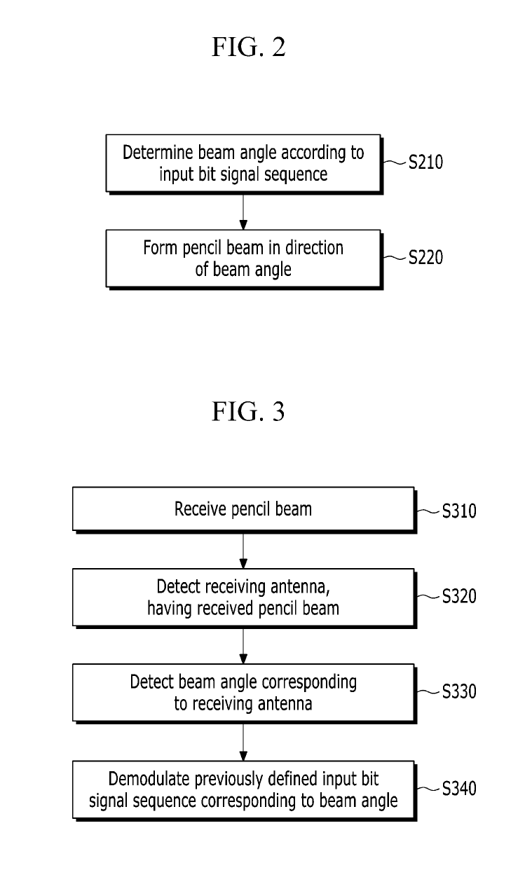

FIG. 2 is a flowchart illustrating a method of transmitting data according to an exemplary embodiment of the present invention, and FIG. 3 is a flowchart illustrating a method of receiving data according to an exemplary embodiment of the present invention.

Referring to FIG. 2, the modulator 110 determines a beam angle according to an input bit signal sequence (S210). The beam angle may include a horizontal direction angle and a vertical direction angle based on a direction vertical to a plane in which an array antenna is located. For example, when a modulation order is M, a beam has a beam angle of 2^{(M/2)} in a horizontal direction and has a beam angle of 2^{(M/2)} in a vertical direction. Therefore, a total of 2^{M} horizontal and vertical beam angle pairs may be obtained. In this case, by setting M input bit strings to one unit, the input bit string is modulated to correspond to one beam angle of 2^{M} beam angle candidates.

As described above, the modulator 110 may modulate a given input bit signal sequence with a method of interlocking an existing digital modulation method and the described beam direction modulation method as well as beam direction modulation of an input bit signal sequence. After modulating a portion (e.g., N bits) of an input bit signal sequence (e.g., M bits) with an existing digital modulation method, the modulator 110 may form a beam of a modulated symbol and transmit the beam by modulating a beam direction in a beam angle corresponding to the remaining input bits (M-N). In this case, as an available existing digital modulation method, a modulation method of Amplitude Shift Keying, Frequency Shift Keying, Phase Shift Keying, and Quadrature Amplitude Modulation may be used, and signals of Code Division Multiple Access (CDMA) or Orthogonal Frequency-Division Multiplexing (OFDM) may be used. Because an existing digital modulation method and a suggested beam direction modulation technique are independently applied, the existing digital modulation method and the suggested beam direction modulation technique may be used to interlock with an available entire digital modulation method as well as the described modulation method.

By forming a pencil beam in a direction of a determined beam angle (S220), the transmitter 120 transmits an input bit signal sequence corresponding to the beam angle.

Referring to FIG. 3, the receiver 210 receives a pencil beam that is applied with a beam angle that is determined by the transmitter 120 (S310).

The receiving antenna detector 220 detects a receiving antenna, having received an applied pencil beam among the plurality of receiving antennas 212 (S320). By selecting a receiving antenna having a largest receiving energy magnitude, the receiving antenna detector 220 may detect a receiving antenna having received an applied pencil beam. For example, a receiving antenna having received a pencil beam may be detected by Equation 1.

$$\hat{i} = arg {max}_{i} {\vert {r}_{i} ( k ) \vert}^{2} \qquad ( Equation 1 )$$

In Equation 1, i is an index of a receiving antenna, and rᵢ(k) represents a receiving signal of an i-th receiving antenna at a slot k.

The demodulator 230 detects a beam angle corresponding to an index of a detected receiving antenna (S330), and demodulates a previously defined input bit signal sequence corresponding to the detected beam angle (S340).

In the data transmitting apparatus 100, when modulating by interlocking an input bit signal sequence with an existing digital modulation method and a beam direction modulation method according to an exemplary embodiment of the present invention, the demodulator 230 may detect a portion (e.g., M-N bit) of an input bit signal sequence according to a detected beam angle, and detect some remaining bits (e.g., N bit) of an input bit signal sequence with a digital demodulation method that is determined in a received signal component. A digital demodulation method may be determined according to a digital modulation method used in the data transmitting apparatus 100.

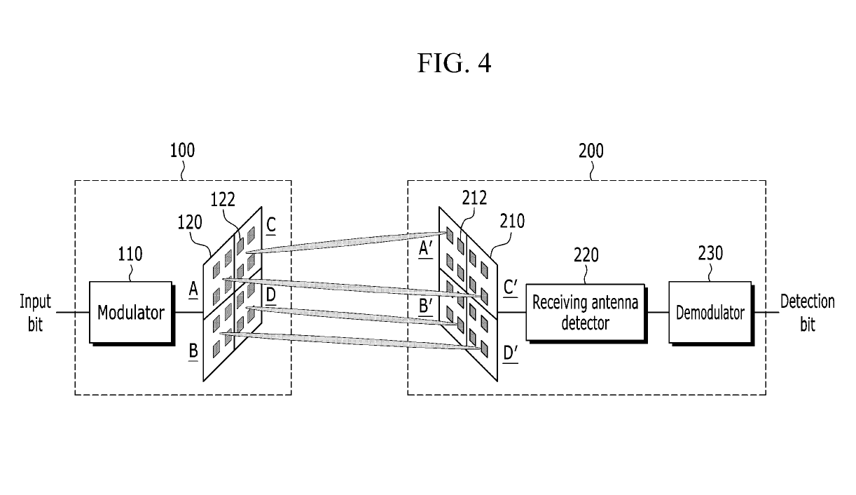

FIG. 4 is a diagram illustrating a wireless communication system according to another exemplary embodiment of the present invention.

Referring to FIG. 4, a plurality of transmitting antennas 122 may be divided into a plurality of transmitting antenna regions A, B, C, and D. Further, a plurality of receiving antennas 212 may be divided into a plurality of receiving antenna regions A′, B′, C′, and D′.

The number of beam angles that are modulated in a transmitting antenna of each of a plurality of transmitting antenna regions A, B, C, and D is the same as the number of receiving antennas that can be distinguished in corresponding receiving antenna regions A′, B′, C′, and D′. That is, a beam angle that is modulated in a transmitting antenna of each of a plurality of transmitting antenna regions A, B, C, and D corresponds one-to-one to a receiving antenna of corresponding receiving antenna regions A′, B′, C′, and D′.

For example, a beam angle that is modulated in a transmitting antenna of a transmitting antenna region A corresponds one-to-one to a receiving antenna of the receiving antenna region A′ corresponding to the transmitting antenna region A. A beam angle that is modulated in a transmitting antenna of the transmitting antenna region B corresponds one-to-one to a receiving antenna of the receiving antenna region B′ corresponding to the transmitting antenna region B. A beam angle that is modulated in a transmitting antenna of the transmitting antenna region C corresponds one-to-one to a receiving antenna of the receiving antenna region C′ corresponding to the transmitting antenna region C. A beam angle that is modulated in a transmitting antenna of the transmitting antenna region D corresponds one-to-one to a receiving antenna of the receiving antenna region D′ corresponding to the transmitting antenna region D. Therefore, when the number of transmitting beam angles that can be distinguished in each antenna region basis is M and when the number of each antenna region is N, a constellation that can be distinguished upon modulating a beam angle has a total magnitude of M^{N}. Therefore, such configuration may be very advantageous in enhancing a data rate.

A modulator 110 determines a beam angle according to an input bit signal sequence, and allocates a beam angle that is determined to different input signal sequences to each of antenna regions A, B, C, and D. For example, the modulator 110 may determine a beam angle of a first input bit signal sequence and allocate the beam angle to the antenna region A, and the modulator 110 may determine a beam angle of a bit signal sequence that is input in a next order and allocate the beam angle to the antenna region B, determine a beam angle of a bit signal sequence that is input in a next order and allocate the beam angle to the antenna region C, and determine a beam angle of a bit signal sequence that is input in a next order and allocate the beam angle to the antenna region D.

The transmitting antenna 122 of each of the antenna regions A, B, C, and D forms a pencil beam in a direction of a beam angle that is determined by the modulator 110 based on the center of a corresponding antenna region. That is, a pencil beam that is formed by each of the antenna regions A, B, C, and D is simultaneously transmitted.

Because different input bit signal sequences may be simultaneously transmitted by the transmitting antenna 122 of each of the antenna regions A, B, C, and D, additional frequency efficiency enhancement due to simultaneous transmission can be obtained.

A receiver 210 receives a pencil beam that is applied with a beam angle that is determined by a transmitter 120, and a receiving antenna detector 220 detects a receiving antenna of each of the receiving antenna regions A′, B′, C′, and D′, having received an applied pencil beam among the plurality of receiving antennas 212 of each of the receiving antenna regions A′, B′, C′, and D′.

A demodulator 230 detects a beam angle corresponding to an index of a receiving antenna of each of the detected receiving antenna regions A′, B′, C′, and D′, and detects an input bit signal sequence according to a beam angle that is detected in each of the receiving antenna regions A′, B′, C′, and D′.

According to an exemplary embodiment of the present invention, by coupling a beam direction-based new modulation technique appropriate to a millimeter wave or terahertz wave-based wireless communication system to an existing modulation technique, additional frequency efficiency increase can be obtained and a characteristic strong on noise due to use of a pencil beam can be obtained.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting data of a data transmitting apparatus in a wireless communication system, the method comprising:
determining a beam angle according to an input bit signal sequence of a determined size; and
forming a pencil beam in a direction of the determined beam angle using a plurality of transmitting antennas.

2. The method of claim 1, wherein angles of a plurality of beams that are modulated by the plurality of transmitting antennas correspond one-to-one to a plurality of receiving antennas in a data receiving apparatus.

3. The method of claim 1, wherein the determining of a beam angle comprises:
generating a modulation symbol by modulating some bits of the input bit signal sequence with a digital modulation method; and
forming the pencil beam by forming a beam of the modulation symbol and determining the beam angle using the remaining bits of the input bit string.

4. The method of claim 1, wherein the forming of a pencil beam comprises:
dividing the plurality of transmitting antennas into a plurality of transmitting antenna regions; and
forming a pencil beam in a direction of a beam angle that is determined for each of different input bit signal sequences at each of the plurality of transmitting antenna regions.

5. The method of claim 4, wherein angles of a plurality of beams that are modulated at each of the plurality of transmitting antenna regions correspond one-to-one to a plurality of receiving antennas of a receiving antenna region corresponding to each of the plurality of transmitting antenna regions.

6. A method of receiving data of a data receiving apparatus in a wireless communication system, the method comprising:
receiving at least one pencil beam that is applied with a beam angle that is determined by a data transmitting apparatus;
detecting at least one receiving antenna that receives at least one applied pencil beam among a plurality of receiving antennas;
detecting a beam angle corresponding to an index of the detected receiving antenna; and
demodulating a bit signal sequence according to the detected beam angle.

7. The method of claim 6, wherein angles of a plurality of beams that are modulated by the plurality of transmitting antennas correspond one-to-one to a plurality of receiving antennas.

8. The method of claim 6, wherein the demodulating of a bit signal sequence comprises:
detecting some bits of the bit signal sequence corresponding to the detected beam angle; and
detecting the remaining bits of the bit signal sequence by demodulating a signal that is received through the pencil beam with a determined digital demodulation method.

9. The method of claim 6, wherein the receiving of at least one pencil beam comprises receiving pencil beams that are simultaneously applied in a beam angle that is determined for each of different input bit signal sequences at each of a plurality of receiving antenna regions, and
the plurality of receiving antennas are divided into the plurality of receiving antenna regions.

10. The method of claim 9, wherein angles of a plurality of beams that are modulated at each of the plurality of transmitting antenna regions correspond one-to-one to a plurality of receiving antennas of a receiving antenna region corresponding to each of the plurality of transmitting antenna regions.

11. A data transmitting apparatus in a wireless communication system, the data transmitting apparatus comprising:
a modulator that determines a beam angle according to an input bit signal sequence of a determined size; and
a transmitter comprising a plurality of transmitting antennas and that forms a pencil beam in a direction of the beam angle that is determined using the plurality of transmitting antennas.

12. The data transmitting apparatus of claim 11, wherein the modulator modulates some bits of the input bit signal sequence with a digital modulation method, forms the pencil beam comprising a modulated signal, and determines a beam angle of the pencil beam using the remaining bits of the input bit signal sequence.

13. The data transmitting apparatus of claim 11, wherein angles of a plurality of beams that are modulated by the plurality of transmitting antennas correspond one-to-one to a plurality of receiving antennas in a data receiving apparatus.

14. The data transmitting apparatus of claim 11, wherein the transmitter divides the plurality of transmitting antennas into a plurality of transmitting antenna regions, and simultaneously forms pencil beams in a direction of a beam angle that is determined for each of different input bit signal sequences at each of the plurality of transmitting antenna regions.

15. The data transmitting apparatus of claim 11, wherein angles of a plurality of beams that are modulated at each of the plurality of transmitting antenna regions correspond one-to-one to a plurality of receiving antennas of a receiving antenna region corresponding to each of the plurality of transmitting antenna regions.

16. A data receiving apparatus in a wireless communication system, the data receiving apparatus comprising:
a receiver comprising a plurality of receiving antennas and that receives at least one pencil beam that is applied with a beam angle that is determined by a data transmitting apparatus through at least one receiving antenna of the plurality of receiving antennas;
a receiving antenna detector that detects at least one receiving antenna that receives the at least one pencil beam among a plurality of receiving antennas; and
a demodulator that detects a beam angle corresponding to an index of the detected receiving antenna and that demodulates a bit signal sequence according to the detected beam angle.

17. The data receiving apparatus of claim 16, wherein the demodulator detects some bits of the bit signal sequence corresponding to a detected beam angle, and detects the remaining bits of the bit signal sequence by demodulating a signal that is received through the pencil beam with a determined digital demodulation method.

18. The data receiving apparatus of claim 16, wherein a plurality of beam angles that are modulated by the plurality of transmitting antennas correspond one-to-one to a plurality of receiving antennas.

19. The data receiving apparatus of claim 16, wherein the receiver divides the plurality of receiving antennas into the plurality of receiving antenna regions, and receives pencil beams that are simultaneously applied to an beam angle that is determined for each of different input bit signal sequences at each of the plurality of receiving antenna regions.

20. The data receiving apparatus of claim 16, wherein angles of a plurality of beams that are modulated at each of the plurality of transmitting antenna regions correspond one-to-one to a plurality of receiving antennas of a receiving antenna region corresponding to each of the plurality of transmitting antenna regions.
